(19) United States
(12) Patent Application Publication
(10) Pub. No.: US 2024/0102447 A1
(43) Pub. Date: Mar. 28, 2024

(54) OVERLOAD PROTECTION ON WIND POWER PLANTS USING STRAIN SENSORS

(71) Applicant: fos4X GmbH, München (DE)

(72) Inventors: Peter Stähler, Planegg (DE); Michael Rüdiger, Neufinsing (DK)

(73) Assignee: fos4X GmbH, München (DE)

(21) Appl. No.: 17/918,205

(22) PCT Filed: May 10, 2021
(86) PCT No.: PCT/EP2021/062266

§ 371 Date: Dec. 8, 2022

(30) Foreign Application Priority Data
May 19, 2020 (DE) 10 2020 113 560.2

(51) Int. Cl. F03D 7/02

(52) U.S. Cl. CPC F03D 7/0224; F05B 2270/322; F05B 2270/327; F05B 2270/332; F05B 2270/808

(57) ABSTRACT

A method (200) for controlling a wind turbine (100) with a rotor having at least one rotor blade (17), the method comprising: measuring (210) a strain of the at least one rotor blade; changing (220) a pitch angle of the at least one rotor blade based at least partially on the measured strain of the at least one rotor blade; whereby the measurement of the strain of the at least one rotor blade measures at least one strain in the area of a blade root of the rotor blade (17).

### TECHNICAL FIELD

The present disclosure relates to methods for controlling a wind turbine and for wind turbines. In particular, methods according to the present disclosure relate to a control of a wind turbine, whereby at least one strain in the area of a blade root of a rotor blade of the wind turbine is measured. Furthermore, methods of the present disclosure relates to changing a pitch angle of a rotor blade of the wind turbine, whereby particularly overload of a generator and/or a converter of the wind turbine is prevented.

### SHORT DESCRIPTION OF THE DRAWINGS

A wind turbine converts wind energy into electrical energy. The wind exerts a force on at least one rotor blade of a rotor of the wind turbine, so that kinetic energy of the wind is converted into kinetic rotational energy of the rotor. The rotor drives an electrical generator that feeds electrical energy into an electricity grid. The generator typically produces an AC voltage.

The force of the wind on the rotor blade varies over time, for example depending on wind gusts, wind strength and wind direction. As a result, both the electrical power generated and the frequency of the electrical voltage generated by the generator and/or the electrical current generated by the generator vary.

With the aid of a converter, it is possible to feed a voltage/current with a constant frequency into the electrical network, based on the voltage/current with a variable frequency that is generated by the generator of the wind turbine.

For example, the AC voltage with variable frequency generated by the generator can be converted into a DC voltage in the converter, whereby an energy storage, such as a capacitor, temporarily stores electrical energy based on the DC voltage, which in turn is used in the converter, for example, for supplying an output voltage/an output current at a constant frequency.

The converter can absorb almost all electric energy of the variable frequency generator, temporarily store energy in the energy storage such as the capacitor based on the generated DC voltage, and feed electric energy into the network with the generation of constant frequency AC current.

In a doubly-fed asynchronous generator, the converter can be configured to feed part of the energy generated by the generator into the network or also to partially conduct energy to the generator. The total output voltage/current of the wind turbine at the grid connection is a combination of the voltage/current generated by the generator and a voltage/current generated by the converter, so that a constant frequency at the grid feed-in point can be guaranteed.

With the use of doubly-fed asynchronous generators, the converter can be dimensioned smaller, since only part of the total energy and total power flows through the converter.

In the case of gusts of wind and/or strong wind, the converter and/or the generator of the wind turbine can be overloaded. Excessively strong wind and/or an excessively strong gust of wind causes an increase in the kinetic energy of the rotor of the wind turbine, which in turn can cause an increase in the electrical power generated by the generator. This can damage the wind turbine generator. If the electrical power generated by the generator exceeds a limit value, the converter can also be damaged, for example if excessive currents flow into the semiconductor elements of the converter.

The kinetic energy of the rotor and/or the kinetic power transferred from the rotor to the electrical generator and/or the electrical power generated by the generator and/or the power flowing through the converter must therefore be limited in order to avoid damage.

The powers mentioned can be limited, for example, by adjusting a pitch angle of a rotor blade.

By adjusting the pitch angle, the force that the wind exerts on the rotor blade can be reduced, thereby reducing the kinetic power transmitted. This reduces the kinetic rotary power of the rotor and the generator generates less electrical power. This prevents overload of the generator and/or the converter.

If the pitch angle is set too late, it may no longer be possible to prevent overload.

If the pitch angle is set too early, wind power that could have been converted into electrical power may be lost.

There is therefore a need to improve methods for changing a pitch angle of the rotor blade as optimally as possible, so that in particular an overload of the generator and/or the converter is effectively prevented without unnecessarily losing wind power from the wind turbine that could still have been converted into electrical power and/or without causing damage to the generator and/or rotor blade.

### SUMMARY

According to one embodiment, a method for controlling a wind turbine with a rotor having at least one rotor blade is disclosed, the method comprising: measuring a strain of the at least one rotor blade; changing a pitch angle of the at least one rotor blade based at least partially on the measured strain of the at least one rotor blade; whereby the measurement of the strain of the at least one rotor blade measures at least one strain in the area of a blade root of the rotor blade.

According to a further embodiment, a wind turbine is disclosed, which comprises: a sensor for measuring a strain of at least one rotor blade of the wind turbine; a control unit configured to change a pitch angle of the at least one rotor blade based at least partially on a strain of the at least one rotor blade measured by the sensor; and wherein the control unit controls the wind turbine according to the above method.

Further embodiments, details and advantages are disclosed according to the dependent claims, the further description and the figures.

### SHORT DESCRIPTION OF THE DRAWINGS

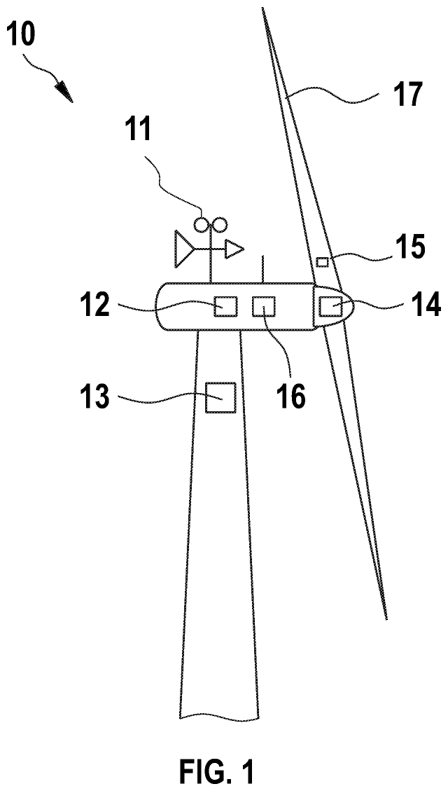

FIG. 1 shows a wind turbine according to embodiments of the present disclosure.

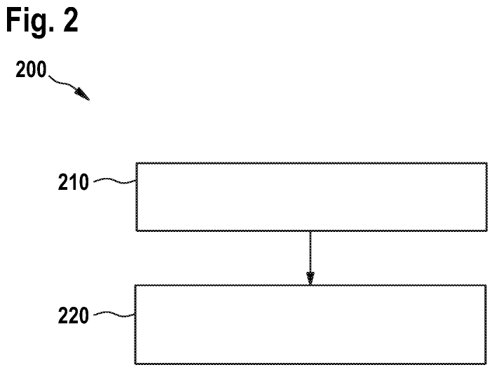

FIG. 2 shows a method for controlling a wind turbine according to the present disclosure.

### DESCRIPTION OF EMBODIMENTS

A wind turbine converts the kinetic energy of the wind into electrical energy or kinetic power into electrical power. Power is to be understood as the energy spent per unit of time or as the time derivative of the energy.

FIG. 1 shows a wind turbine according to embodiments of the present disclosure.

The wind turbine 10 includes at least one rotor blade, which drives a rotor 14. The wind collides with the rotor blade 17 and thereby a force acts on the rotor blade, which causes a torque of the rotor. As a result, the rotor 14 and the rotor blade 17 are accelerated until an equilibrium arises by an opposing torque. This opposing torque may be a torque from an electrical generator 16 that converts rotational kinetic energy into electrical energy and/or a torque caused by friction.

A wind turbine 10 may include a converter 12, which is used in particular to enable/generate an AC current with a constant frequency, based on the AC current/AC voltage generated by the generator 16, which does not have a constant frequency because the wind does not cause a constant rotational speed of the rotor 14.

A wind turbine 10 can also contain a wind gauge (anemometer) 11 and/or a control system 13 which can in particular control or stimulate a pitch angle of the rotor blade 17. By adjusting the pitch angle of the rotor blade 17, it is possible to vary the force that the wind exerts on the rotor blade. This changes the rotor blade torque generated by the wind.

A torque of the generator 16 and/or a transmission ratio of the rotational speed of the rotor 14 to the generator 16 can also be changed, for example by setting a gear.

For a given wind speed, the electrical power that can be gained is limited. If the wind speeds are too high, the wind turbine can be damaged. For example, the generator may be overloaded with kinetic power and/or the converter with electrical power, wherein overload of the converter/generator in the present disclosure means that a maximum nominal power is exceeded, either to the converter/generator and/or from the converter/generator.

The wind turbine 10, according to embodiments of the present disclosure, comprises at least one strain sensor 15 in a blade root of a rotor blade 17.

If a wind turbine 10 is in full-load operation during a strong wind phase, an emerging overload in the form of a gust of wind with an increased wind speed can damage the converter 12. If the regulation of the system reacts too late to the overload, the electrical energy generated by the generator 16 in the converter 12 can no longer be processed correctly. The consequence is short-term operation of the converter beyond its performance parameters and damage thereof. The result is failure of the wind turbine until the damage is repaired. This leads to high costs and a loss of electrical energy.

An overload of the generator and/or the converter of a wind turbine occurs when too much kinetic power is supplied from the rotor to the generator or when too much electrical power flows through the converter, which, for example, exceeds a maximum permissible rated power.

For example, if the wind intensity is too strong or there is a too strong gust of wind, the rotational power of the rotor can increase markedly, which can possibly lead to an increase in the electrical power generated by the generator in a very short time, which can damage the generator, and/or the converter can be damaged, for example by excessive currents flowing in the semiconductor elements of the converter, which for example exceed a maximum rated current of the semiconductor elements.

A conventional regulation of the system based on the power curve of the system compares the currently generated power with a stored reference curve. The wind turbine is controlled into a stable state by varying the pitch angles of the rotor blades. This regulation cannot effectively prevent an overload, since the variance of the pitch angles requires some time in which the power can continue to increase, during which the converter can be damaged.

In order to prevent or avert overload of the converter and/or the generator, it is not sufficient to observe and measure the electrical output of the generator. Nor is it sufficient to observe and measure for example, a kinetic energy and/or a time derivative thereof, for example a kinetic energy or power of the rotor, Thus, if an increase is measured that indicates an overload, it is no longer possible to adjust the pitch angle quickly in order to still be able to effectively prevent the overload.

So if a power increase is measured at the generator or at the rotor, adjusting the pitch angle of the rotor blade and/or braking the rotor would only lead to an effective reduction in the kinetic power absorbed by the wind after some time and therefore only to an effective reduction after some time result in a power reduction of the generator and/or of the converter. Before the power reduction actually occurs, damage to the converter or the generator cannot be ruled out, for example if a further increase in wind intensity causes the power to continue to rise while the pitch angle is being adjusted.

Also, overload cannot be effectively prevented by measuring wind intensity. First of all, local measurements, for example by a wind turbine anemometer, are subject to error. In addition, the field of wind intensity in the vicinity of the wind turbine can be irregular or turbulent, so that a local or punctuated wind measurement is not suitable for drawing effective conclusions about the power that is transmitted from the wind to the rotor of the wind turbine, especially in the event of strong gusts of wind, which change rapidly.

Measuring the entire wind field, for example with a LIDAR, in the vicinity of the wind turbine is complex and conclusions about possible overload are only possible indirectly through calculations and evaluations of the measured data.

A measurement of the wind field at a greater distance, e.g. using a more distant LIDAR of a wind farm in which the wind turbine is located, is also unreliable, since the wind intensity and wind direction can vary greatly locally, especially in the case of strong gusts, or not be accurately determined by measuring the more distant wind field can be determined.

It is therefore necessary to measure or detect an increase in the wind power transmitted by the wind to the rotor, in particular to effectively prevent overload of the converter or generator, in particular without using a wind gauge, anemometer or LIDAR.

An increase in the kinetic power transferred from the wind to the rotor leads to a bending of the rotor blade, since the at least partially elastic rotor blade is subjected to a greater force. This bending leads to a distortion of the rotor blade, particularly in the area of a blade root of the rotor blade.

The bending moment is proportional to the measured strain. If there is a jump in strain, the bending moment will also change in jumps.

The elasticity of the rotor blade causes a delay between the strain and a strong acceleration of the rotor. If the strain exceeds a threshold, it is possible to intervene quickly according to the present disclosure. Damage to the converter/generator, for example, can be prevented, Without intervention, damage can occur after just 5 s due to overload and damage to the converter. The rotor blade can be adjusted in 3 s, but as soon as the adjustment begins, the power drops rapidly and the damage/overload is prevented in a timely manner.

Measuring the bending of the rotor blade makes it possible to effectively measure an increase in the kinetic power and energy of the rotor or to predict and/or detect an increase in the elasticity of the rotor blade and thereby makes it possible to effectively prevent overload of the converter or generator.

In particular, due to the mass inertia of the rotor/rotor blade, the rotor blade bending already occurs, when the wind intensity increases and the wind force acting on the rotor blade increases as a result, even before the electrical power at the generator increases significantly.

By using at least one strain sensor 15 in the area of the blade root, a case of overload can be detected earlier. Due to the mass inertia of the rotor, there is increased bending of the rotor blades even before the rotor accelerates and transfers the absorbed energy to the generator. If the information obtained by the at least one strain sensor 15 is used, the system can change the pitch angle of the rotor blades at an early stage and thus prevent the overload from being absorbed.

Strain sensors, such as the strain sensor 15, are able to detect the increased bending of the rotor blades even before the rotor itself accelerates and supplies the energy/power to the generator. In this way, the sensor system in the rotor blade detects the occurring critical state even before the overload occurs, By contrast, previous methods only intervene when overload occurs and/or when there is an increase in the power of the generator, By using strain sensors to prevent overload, further damage to the wind turbines can be prevented.

By using strain sensors, an occurring overload can be detected even before the energy is led into the system of the wind turbine. This means that damage prevention measures can be initiated even before the problem occurs. The regulation of the system is no longer only possible as purely reactive to energy already introduced, but rather preventive.

By using signals that occur earlier than the critical state itself, such as signals of bending of the rotor blade, the time window for initiating measures to avoid damage increases. The present disclosure can be applied to any wind turbine without interfering with the safety chain.

For example, a threshold value for the strain sensors can be set. If the threshold value is exceeded, the wind turbine can either stop or be switched to a reduced operating state for a short time.

The present disclosure measures or detects an increase in the wind strength/wind speed with a time delay before the increase would initiate the overload without measures. The time delay is sufficient to effectively prevent the overload that would otherwise occur by adjusting a pitch angle. The time delay is caused, for example, by the mass inertia of the rotor.

One embodiment of the present disclosure is a method 200 (see FIG. 2) for controlling a wind turbine having a rotor with at least one rotor blade, the method comprising: measuring 210 a strain of the at least one rotor blade; changing 220 a pitch angle of the at least one rotor blade based at least partially on the measured strain of the at least one rotor blade; whereby the measurement of the strain of the at least one rotor blade measures at least one strain in the area of a blade root of the rotor blade.

According to one embodiment, measuring the strain of the at least one rotor blade detects a bending of the at least one rotor blade, which indicates imminent acceleration of the rotor.

The bending is in particular a strain of the rotor blade, for example at the blade root of the rotor blade, which exceeds a predetermined threshold value. Not every strain is therefore to be seen as a bending, but only a strain that exceeds a threshold value.

According to one embodiment, the pitch angle of the at least one rotor blade is changed as soon as the bending is detected in order to prevent the rotor from accelerating in the near future.

According to one embodiment, changing the pitch angle prevents overload of a generator and/or a converter of the wind turbine, as power that is transmitted from the rotor blade to the generator and/or the converter remains limited.

As soon as the bending is detected/determined/recorded, for example as soon as the strain exceeds a predetermined threshold value, the pitch angle of the rotor blade is changed in order to prevent the rotor from being accelerated in the near future, in particular to prevent the converter and/or the generator from being overloaded by continued limitation of the power that is transferred from the rotor blade to the converter and/or generator.

A strain of the rotor blade is normal during normal operation of a wind turbine, and acceleration of the rotor blade is also part of normal operation of a wind turbine.

When wind at a certain wind speed hits a stationary rotor blade, the rotor blade is strained and the rotor accelerates. Acceleration is an angular acceleration of the rotor caused by the torque of the rotor caused by the applied force of the wind. The rotor is simultaneously braked by counteracting torque from the generator and/or by friction. As the angular speed of the rotor increases with the wind speed remaining constant, the torque caused by the wind decreases as a relative speed/movement of the wind towards the surface of the rotor blade decreases. When there is an equilibrium between the torque caused by the wind and the torque caused by the generator and/or friction, then the angular velocity of the rotor remains constant and kinetic power flows from the wind to the generator that generates the electrical power.

In normal operation, the strain of the rotor blade, for example the strain of the root of the rotor blade, remains limited.

Excessive wind speed, such as a gust in a storm, would cause more rotor blade and/or rotor blade root strain, and torque equilibrium would occur at a higher generator torque, thereby generating more electrical power from the generator which could, for example, damage the converter and/or damage the generator itself.

If the strain of the rotor blade or the blade root exceeds a threshold value, a future overload of the converter and/or generator can then be expected without measures being taken. If the threshold value is exceeded, the overload occurs faster the more the threshold value is exceeded.

The threshold value can be defined, for example, as the supremum of the amount of strains for which, when the future equilibrium of the torques of the wind and the generator on the rotor occurs, a maximum rated power of the electrical generator and/or a maximum rated power flowing through the converter are not exceeded, especially so that no damage occurs to the converter and/or the generator.

The threshold value can also depend on a current rotational speed of the rotor. For example high strain of the rotor blade at high rotational speed can be more critical than when the rotor is stationary or at low rotational speed, since high strain at high rotational speed indicates a further increase in an already high power.

Exceeding the threshold value is therefore a bending of the rotor blade for the purpose of this this disclosure. Bending therefore always occurs when the strain exceeds the threshold value, with the threshold value being either constant or a function of the current rotational speed of the rotor, possibly depending on other parameters of the wind turbine, such as a torque of the generator and/or a rotational speed transmission ratio between rotor and generator, an electric load, etc.

According to one embodiment, the strain is measured using a fiber-optic strain sensor 15, which is arranged in the blade root of the at least one rotor blade and which in particular comprises a Fiber Bragg Grating.

According to one embodiment, a strain is measured for all rotor blades of the rotor blade and the changing of the pitch angle is based in particular on the measured strain of all rotor blades.

According to one embodiment, changing the pitch angle is also based on a power and/or a rotational speed of the rotor.

For example, the threshold value of the strain of the blade root and accordingly also the detection of the bending of the rotor blade can be dependent on the rotational speed of the rotor.

For example, the threshold of blade root strain and corresponding detection of rotor blade bending may be independent of rotor rotational speed, but changing the pitch angle is based at least partially on power and/or rotational speed of the rotor. For example, the amount of change in the pitch angle can be greater if there is higher power and/or a higher rotational speed of the rotor while the bending remains the same, i.e. if a constant threshold value of the strain of the blade root of the rotor blade is exceeded.

According to one embodiment, changing the pitch angle is also based on a measured wind speed, in particular on a wind speed measured by an anemometer or LIDAR.

The detection of the bending and/or exceeding of the threshold value can thus be supplemented with additional measurements in order to improve the predictive power of the overload. It can thus be differentiated whether a short gust of wind hits the rotor blade once or repeated violent gusts of wind are to be expected. A differentiated decision can thus be made as to whether, for example, the wind turbine should be turned down or stopped.

According to one embodiment, measuring the strain measures a strain between a first point and a remote second point on the rotor blade between which an optical fiber including, for example, a Fiber Bragg Grating is clamped.

Some embodiments relate to a wind turbine comprising: a sensor for measuring a strain of at least one rotor blade of the wind turbine; a control unit configured to change a pitch angle of the at least one rotor blade based at least partially on a strain of the at least one rotor blade measured by the sensor; and wherein the control unit controls the wind turbine according to methods of the present disclosure.

Some embodiments relate to a wind farm with at least one wind turbine according to the present disclosure.

The use of glass fiber sensors, such as Fiber Bragg Grating sensors, enables installation of the strain sensors in the area of the blade root. In particular, this enables improved control of the individual wind turbine.

As soon as a strain exceeds a threshold value, the turbine can be stopped or controlled quickly in order to effectively and advantageously avoid damage, for example to avoid overload of a converter and/or generator of the wind turbine. A preventive intervention is made possible, whereas in the prior art there is only a reactive reaction to energy that has already been led in.

The present disclosure enables effective and cost-effective control of each individual wind turbine, in particular to prevent damage to the individual wind turbine.

The strain sensors, in particular the Fiber Bragg Grating sensors, are robust and durable, inexpensive and easy to install.

Overload and/or damage to the converter/generator, for example, can be effectively prevented without using a LIDAR. A LIDAR is associated with considerable costs and installing a LIDAR for each individual wind turbine is complex and expensive. A LIDAR can also be inaccurate because it captures remote wind data, while actual local wind conditions can be chaotic and difficult to determine. In contrast, measuring blade root strain according to the present disclosure is accurate, efficient, in real time and inexpensive.

A strain can also be measured for each individual rotor blade, whereas an anemometer, for example, can only perform an inaccurate local wind measurement for the wind turbine as a whole. Even with a LIDAR, the strain of individual rotor blades cannot be measured or recorded. The present disclosure thus enables more accurate conclusions about the torque of the rotor and/or impulsive accelerations of the rotor which can lead to overload and enables effective and timely intervention in order to prevent overload or damage to the converter/generator, for example.

The strain sensors of the present disclosure, for example, optical fiber cable sensors with Fiber Bragg Grating are more robust and durable than anemometers and/or LIDAR sensors.

The present disclosure does not require complex models and/or abstractions and/or extensive calibrations. A simple comparison with a threshold value is sufficient to measure/record an accurate strain and/or bending in the root area of an individual rotor blade in order to be able to effectively prevent damage/overload, for example of the converter and/or generator.

An anemometer is inaccurate even after extensive calibration, whereas according to the present disclosure calibration is not required and/or can be performed very easily. A LIDAR is not typically part of a single wind turbine. The installation of strain sensors is unproblematic and inexpensive, especially compared with the installation of a LIDAR.

1. A method for controlling a wind turbine with a rotor having at least one rotor blade, the method comprising:
measuring, with a sensor, a strain of the at least one rotor blade;
changing a pitch angle of the at least one rotor blade based at least partially on the measured strain of the at least one rotor blade;
whereby the measuring of the strain of the at least one rotor blade measures at least one strain in an area of a blade root of the at least one rotor blade.

2. A method according to claim 1, whereby measuring the strain of the at least one rotor blade detects a bending of the at least one rotor blade, which indicates imminent acceleration of the rotor.

3. A method according to claim 2, whereby the pitch angle of the at least one rotor blade is changed as soon as the bending is detected in order to prevent the imminent acceleration of the rotor.

4. A method according to claim 1, whereby changing the pitch angle is configured to prevent overload of a generator and/or a converter of the wind turbine by limiting power that is transmitted from the at least one rotor blade to the generator and/or the converter.

5. A method according to claim 1, whereby the measurement of the strain is performed with a fiber-optic strain sensor,
which is arranged in the blade root of the at least one rotor blade, and
which includes a Fiber Bragg Grating.

6. A method according to claim 1, whereby a strain is measured with a sensor for all rotor blades of the rotor, and whereby the changing of the pitch angle is based on the measured strain of all rotor blades.

7. A method according to claim 1, whereby changing the pitch angle is additionally based on a power and/or a rotational speed of the rotor.

8. A method according to claim 1, whereby the changing of the pitch angle is additionally based on a measured wind speed.

9. A method according to claim 1, whereby the step of measuring the strain includes measuring a strain between a first point on the at least one rotor blade and a distant second point on the at least one rotor blade, where an optical fiber is clamped between the first point and the distant second point.

10. A wind turbine configured to operate according to the method of claim 1, the wind turbine comprising:
the sensor configured for measuring a strain of the at least one rotor blade of the wind turbine;
a control unit configured to change a pitch angle of the at least one rotor blade, based at least partially on a strain of the at least one rotor blade as measured by the sensor; and
wherein the control unit is configured to control at least the pitch angle of the at least one rotor blade.

11. A wind farm with at least one wind turbine according to claim 10.

12. A method according to claim 8, where the measured wind speed is measured by one or more of a wind gauge, an anemometer, and LIDAR.

13. A wind turbine configured to operate according to the method of claim 1, the wind turbine comprising:
the sensor for measuring a strain of the at least one rotor blade of the wind turbine being configured as a fiber-optic strain sensor arranged in the blade root of the at least one rotor blade;
a control unit configured to change a pitch angle of the at least one rotor blade, based at least partially on a strain of the at least one rotor blade as measured by the sensor; and
wherein the control unit is configured to control at least the pitch angle of the at least one rotor blade.

14. A wind turbine according to claim 13, where the fiber-optic strain sensor includes a Fiber Bragg Grating.

15. A wind turbine according to claim 13, comprising an optical fiber clamped between a first point of the at least one rotor blade and a second point of the at least one rotor blade.

16. A wind turbine according to claim 15, where the optical fiber includes a Fiber Bragg Grating.

17. A wind farm with at least one wind turbine according to claim 16.

18. A wind turbine according to claim 13, where the control unit is further configured to change the pitch angle based additionally on a power of the rotor and/or a rotational speed of the rotor.

19. A wind turbine comprising:
a rotor including at least one rotor blade;
a fiber-optic strain sensor configured for measuring a strain between a first point and a second point, remote from the first point, of the at least one rotor blade of the wind turbine; and
a control unit configured to change a pitch angle of the at least one rotor blade, based at least partially on a strain of the at least one rotor blade as measured by the sensor;
wherein the sensor configured as a fiber-optic strain sensor arranged in a blade root of the at least one rotor blade.

20. A wind turbine according to claim 19, where the optical fiber includes a Fiber Bragg Grating, and where the control unit is configured to change the pitch angle based additionally on a power of the rotor and/or a rotational speed of the rotor.
